(19) United States
(12) Patent Application Publication
(10) Pub. No.: US 2019/0283891 A1
(43) Pub. Date: Sep. 19, 2019

(54) NACELLE FOR AN AIRCRAFT POWER UNIT

(71) Applicant: AIRBUS OPERATIONS (S.A.S.), Toulouse (FR)

(72) Inventors: Jérôme COLMAGRO, Toulouse (FR); Mathias TOURIN, Colomiers (FR)

(21) Appl. No.: 16/351,978

(22) Filed: Mar. 13, 2019

(30) Foreign Application Priority Data
Mar. 14, 2018 (FR) 1852198

(51) Int. Cl. B64D 29/04; B64D 29/06; B64D 33/04; B64D 27/20

(52) U.S. Cl. CPC B64D 29/04; B64D 27/20; B64D 33/04; B64D 29/06

(57) ABSTRACT

An aircraft power unit is disclosed having an engine, which an output shaft linked to a driveshaft of a fan positioned downstream of the engine. The fan is included in a duct formed by a nacelle of the power unit. The nacelle is linked to the driveshaft of the fan by a nacelle pivot formed downstream of the fan.

### CROSS REFERENCE TO RELATED APPLICATION

This application claims priority to and incorporates by reference French Patent Application Number 1852198, filed Mar. 14, 2018.

### BACKGROUND

### 1. Field of the Invention

The disclosure generally relates to aircraft power units, and mores specifically to a nacelle for an aircraft power unit.

### 2. Description of the Related Art

Commercial aircraft generally have a general architecture having a fuselage, an airfoil comprising two wings, and a rear tail (and/or “duck” if necessary). Such aircraft may comprise one or more power units, which are commonly jet engines. The power units can be installed according to various configurations. They can for example be suspended under the airfoil by support pylons, or fixed to the rear of the fuselage by pylons or at the tail unit.

In flight, the outer surfaces of the aircraft influence the flow of the air. In particular, in the movement of an aerodynamic profile in air, a boundary layer is created on the surface of the aerodynamic profile. This boundary layer corresponds to the zone in which the rate of flow of the air flow is slowed down by the surface of the profile (or other body) because of the viscosity of the air.

Generally, the aircraft power units are configured so as not to suck in the boundary layer created on a surface of the aircraft. Thus, the power units are commonly mounted in such a way that their air input is situated in a free air flow, which is disturbed little or not at all by the surface of the aircraft. For example, the power units are arranged under the airfoil, or at a distance from the fuselage for a mounting in the rear part of the aircraft.

Nevertheless, the ingestion by the power unit of the boundary layer offers some advantages compared to the power units mounted in a free air flow. In effect, when a jet engine is mounted in a free air flow, the excess kinetic energy in the jet is lost. When the unit is in the core of the slower flow of the boundary layer, there is less excess kinetic energy, and comparatively less energy is required to obtain an equal thrust. Also the power unit returns energy into the wake, which reduces the drag.

Improving the efficiency of the propulsion of aircraft is currently a major issue, in order to reduce their specific consumption (that is to say the fuel consumption relative to the mass of the aircraft). The ingestion of the boundary layer by a power unit, generally referred to as “BLI” or “Boundary Layer Ingestion” is considered according to various configurations.

According to one configuration, one or more power units are located in the rear part of the fuselage.

An example of power unit with boundary layer ingestion is represented in FIGS. 1 and 2 comprising an engine 2, for example a turbine engine, of which an output shaft 11 rotationally drives a rear fan 6, that is to say a fan 6 positioned downstream of the turbine engine in the direction of the air flow passing through the power unit.

The fan 6 is contained in a nacelle 3 forming an aerodynamic fairing. In order to produce the mechanical securing of the nacelle 3, in the power units intended to be mounted at the rear of a fuselage like that represented in FIGS. 1 and 2 that are attached hereto and described in more detail hereinbelow, linking the nacelle 3 of the fan 6 to the end of the fuselage by faired struts 8, 9, linked to the nacelle 3 upstream of the fan 6, is considered.

Throughout the present document, the concepts of upstream and downstream refer to the direction of flow of the propulsion gases, in particular of the air, in the power unit, and in particular in the duct formed by its nacelle 3.

In this configuration, because of the stresses exerted on the nacelle for example by the vertical or horizontal gusts, the nacelle 3 can undergo movements such that the separation between the end of the blades of the fan 6 and the nacelle 3 cannot be kept constant, and equal over all the periphery of the fan 6.

### SUMMARY

In an exemplary embodiment, an aircraft power unit is disclosed that solves this problem and a rear part of aircraft fuselage comprising such a power unit with boundary layer ingestion. Thus, the invention relates to an aircraft power unit comprising an engine of which an output shaft is linked to a driveshaft of a fan positioned downstream of the engine. The fan is included in a duct formed by a nacelle of the power unit. The nacelle is linked to the driveshaft of the fan by a nacelle pivot formed downstream of the fan.

In an exemplary embodiment, a power unit is disclosed in which its configuration makes it possible to limit the deformations of the nacelle when it is subjected to mechanical stresses. That makes it possible to guarantee a constant separation between the fan and the nacelle, for example, a separation that is equal between the end of the blades of the fan and the nacelle over all the periphery of the fan. The efficiency of the power unit is thus enhanced.

The nacelle pivot can be rigidly linked to the nacelle by a set of fixed blades. The aircraft power unit can comprise no direct mechanical link, formed in the duct or facing an input of the duct formed by the nacelle, between the engine and the nacelle. The nacelle pivot can comprise at least two rolling bearings separated from one another along the driveshaft of the fan.

The nacelle pivot may comprise at least one ball bearing and one roller bearing. The invention relates also to an aircraft rear part comprising a fuselage rear portion and at least one aircraft power unit as described previously, in which a part of the engine of the power unit is included in the fuselage rear portion and in which no direct mechanical link is formed in the duct or facing an input of the duct formed by the nacelle between the fuselage rear portion and the nacelle.

The driveshaft of the fan can be linked to the fuselage rear portion by at least two rolling bearings separated from one another along the driveshaft of the fan. The rolling bearings can comprise at least one ball bearing and one roller bearing.

The invention relates finally to an aircraft comprising a rear part as described previously.

### BRIEF DESCRIPTION OF THE DRAWINGS

For an understanding of embodiments of the disclosure, reference is now made to the following description taken in conjunction with the accompanying drawings, in which:

FIG. 1 is a three-dimensional schematic view of an aircraft power unit as installed on an aircraft;

FIG. 2 is a cross-sectional view the power unit of FIG. 1;

FIG. 3 is a schematic diagram of the configuration of the power unit of FIGS. 1 and 2;

FIG. 4 is a schematic diagram similar to that of FIG. 3 illustrating the slight deformation configuration;

FIG. 5 is a cross sectional view of the configuration of a power unit according to an exemplary embodiment;

FIG. 6 is a cross sectional view of the power unit shown in FIG. 5 in which the deformation is illustrated;

FIG. 7 is a cross-sectional view of a power unit according to an exemplary embodiment of the invention; and,

FIG. 8 is a perspective view of the power unit of FIG. 7 installed at the rear of the fuselage of an aircraft.

In the accompanying drawings, like reference characters refer to the same or similar parts throughout the different views. The drawings are not necessarily to scale, emphasis instead being placed upon illustrating particular principles, discussed below.

### DETAILED DESCRIPTION OF SOME EMBODIMENTS

Some embodiments will now be described with reference to the Figures.

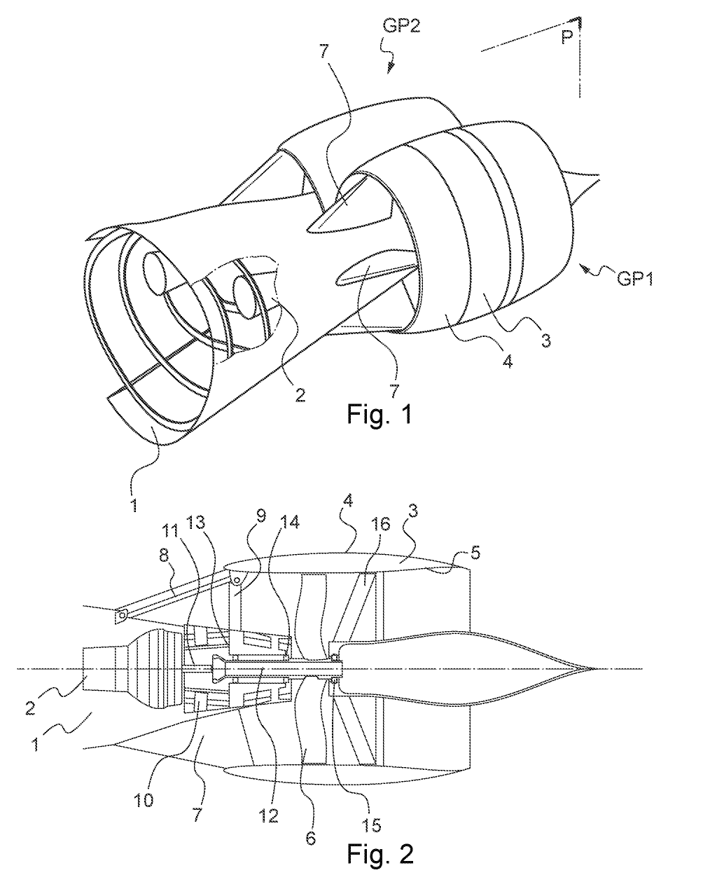

FIG. 1 represents an aircraft power unit and its installation on an aircraft according to an embodiment considered prior to the invention. More specifically, FIG. 1 represents a first power unit GP1 and a second power unit GP2 installed side by side in a fuselage rear portion 1. The power units and the fuselage rear portion 1 constitute the rear part of an aircraft. The power units GP1, GP2 are identical, such that just one of the power units GP1, GP2 is detailed hereinbelow, in this case the first power unit GP1, hereinafter designated “the power unit”.

The power unit comprises an engine 2 which is essentially included in the fuselage rear portion 1. The engine can be a turbine engine, in particular a turbojet engine, whose rear part can form the rear end part of the fuselage. In the example represented here, the turbine engine is positioned upstream of the fan, and the ejection cone is positioned downstream thereof.

The power unit also comprises a nacelle 3 in which a fan is installed. The nacelle 3 comprises an outer aerodynamic fairing 4, and an inner aerodynamic fairing 5. The inner aerodynamic fairing 5 forms a duct for the aircraft propulsion gases. The fan 6 is installed in the duct of the nacelle 3.

The nacelle 3 of the power unit is linked to the fuselage rear part 1. The mechanical links between the nacelle 3 and the fuselage rear part 1 can be formed by struts incorporated in strut fairings 7.

One drawback with this configuration lies in the presence of the strut fairings 7 which form a hindrance to the entry of the air into the nacelle 3.

FIG. 2 represents the power unit GP1 of FIG. 1 in cross section, along the longitudinal cutting plane P represented in FIG. 1. The main axis (of rotation of the engine and of the fan) of the first power unit GP1 is located in the plane P, which is called vertical, that is to say that the plane P is orthogonal to the plane containing the main axes of the first and second power units GP1, GP2.

In FIG. 2, one of the strut fairings 7 is cut away, and reveals a first strut 8 and a second strut 9, linking one and the same point of the nacelle 3 to two points of the fuselage rear portion 1. In particular, the first strut 8 links a point of the nacelle 3 to a structural element of the fuselage, and the second strut 9 links this same point to a rear part of the turbojet engine 10 which is part of the engine but forms the rear end part of the fuselage. That forms a link between the fuselage rear portion 1 and the front of the nacelle 3.

The engine 2 comprises an output shaft 11 which is linked to a driveshaft 12 of the fan 6. The output shaft 11 can rotate the driveshaft 12, and the fan 6 is rigidly mounted on the driveshaft 12.

Another drawback with the power unit configuration of FIGS. 1 and 2 lies in the proximity between the trailing edge of the strut fairings and the fan 6. This proximity creates an effect of successive masking of the blades of the fan, causing load variations on the blades of the fan and the generation of noise.

The driveshaft 12 is pivot-linked to the fuselage rear portion, and more specifically to the rear part of the turbojet engine forming the rear part of the fuselage rear portion 1.

Throughout the disclosure, a pivot denotes a link with a single degree of freedom, in rotation about an axis. In particular, a ball joint exhibiting this same degree of freedom out of these degrees of freedom does not constitute a pivot within the meaning of the present document.

The pivot formed between the driveshaft 12 and the fuselage rear portion 1, in the rear part of the turbojet engine 10, is formed, in the example represented, by two rolling bearings spaced apart from one another along the driveshaft 12 and arranged on the driveshaft 12 upstream of the fan 6. This pivot is called fuselage pivot.

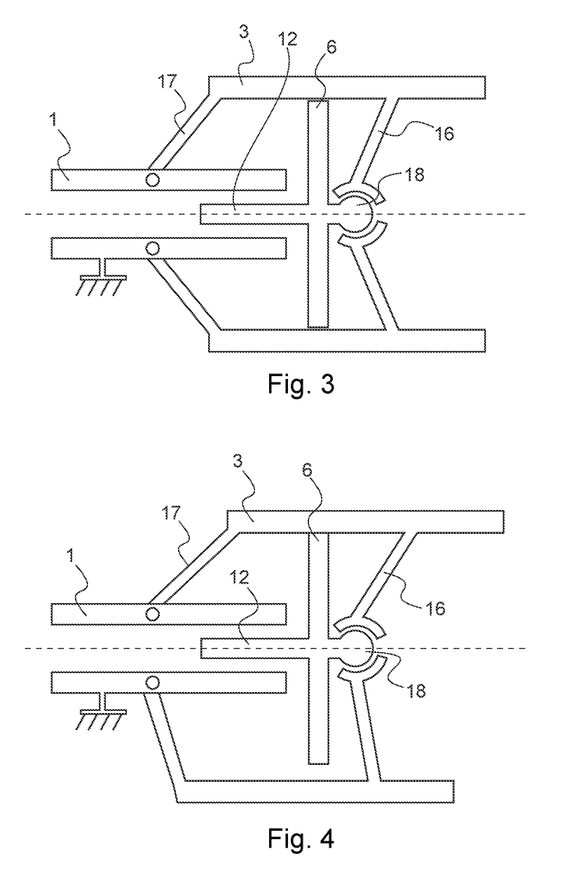

A first rolling bearing 13 may be a ball bearing, and a second rolling bearing 14 may be a roller bearing. This combination allows for a good absorption of the radial and axial loads, namely of the axial loads by the first, ball bearing 13, and of the radial loads essentially by the second, roller bearing and part by the first, ball bearing 13. Downstream of the fan 6, the driveshaft 12 bears a rear rolling bearing 15. The rear rolling bearing allows the rotation of the driveshaft 12 with respect to a set of fixed blades 16 linked also to the nacelle 3. FIGS. 3 and 4 illustrate another drawback of the configuration.

FIG. 3 schematically represents the behavior of the links implemented between the power unit and the fuselage rear portion 1 which are represented in FIGS. 1 and 2.

The fuselage rear portion 1 is considered as a fixed element. The first and second struts 8, 9 can be modelled, at least for movements of low amplitude of the nacelle 3, as a single strut 17, pivot-linked to the fuselage rear portion 1. The link between the fixed blades and the driveshaft 12 can be modelled as a ball joint 18.

The nacelle 3 undergoes, in the flight of the aircraft which is equipped therewith, significant mechanical stresses. These mechanical stresses are linked for example to vertical or horizontal wind gusts, or to some aircraft landing conditions.

FIG. 4 illustrates the effect that these stresses can have on the power unit. More specifically, FIG. 4 illustrates the deformation that the nacelle 3 can exhibit under the effect of stresses given the configuration of its links with the fuselage rear portion 1 and the driveshaft 12. Quite obviously, the movements and deformations are shown in a highly exaggerated manner in FIG. 4, for purely illustrative purposes. In FIG. 4, because of the deformation of the nacelle 3, the distance between the end of the blades of the fan and the inner aerodynamic fairing 5 of the nacelle is not equal over all the periphery of the fan. Typically, in an extreme case illustrated in FIG. 4, a contact, a friction or an extreme proximity between the fan 6 and the inner aerodynamic fairing 5 of the nacelle can occur on one side of the nacelle, whereas on the diametrically opposite side, a significant gap is created between the fan 6 and the inner aerodynamic fairing 5 of the nacelle. This greatly impacts the efficiency of the power unit.

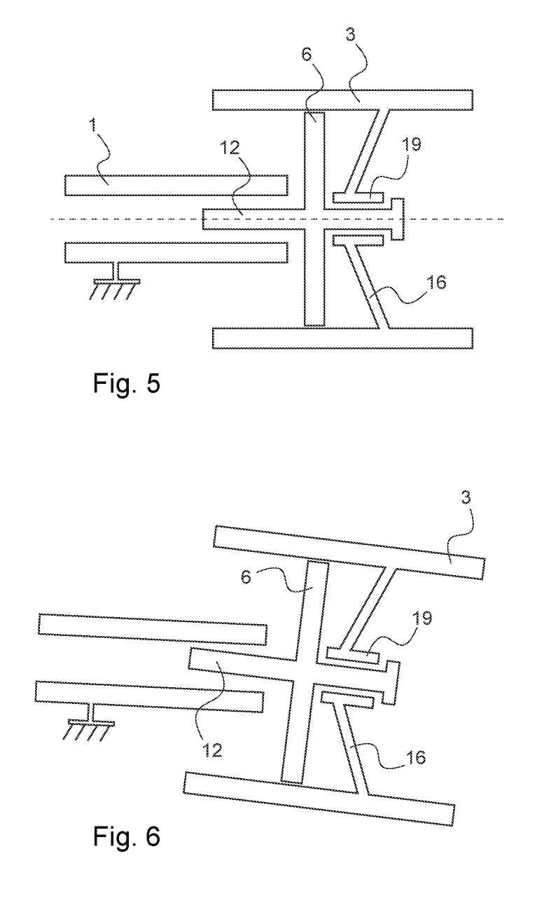

The aircraft power unit configuration developed in the invention is illustrated in FIG. 5. In the embodiment of the invention illustrated in FIG. 5, the nacelle 3 is linked to the driveshaft of the fan by a pivot, called nacelle pivot 19, instead of the ball joint formed in the configuration represented in FIGS. 1 to 4.

Furthermore, no strut or other mechanical link directly links the nacelle to the fuselage rear portion 1, or to the engine in the rear part of the turbojet engine 10. A direct mechanical link is understood to be a link in which a mechanical part is interposed between two elements in order to link them. The link from the nacelle to the engine via the nacelle pivot, and the driveshaft 12 linked to the output shaft 11, thus does not constitute a direct mechanical link. In effect, there is no link piece interposed directly between the nacelle and the engine: the link between the engine and the nacelle is produced by the fan driveshaft (which is linked to the engine output shaft) and the fixed blades 16 via the nacelle pivot 19. Thus, compared to the configuration represented in FIGS. 1 to 4, it is proposed, in the invention, to replace the ball joint link formed between the driveshaft of the fan with a pivot link. Furthermore, the struts linking the nacelle to the engine, in particular in the rear part of the turbojet engine 10, are eliminated.

FIG. 6 illustrates the effect that stresses similar to those whose effect is illustrated in FIG. 4 and applied to the nacelle 3 can have. In FIG. 6, the absence of strut will allow a movement of the nacelle without causing the deformation thereof. Just as in FIG. 4, the movement of the nacelle is, here, greatly augmented in order to show the nature thereof. The pivot of the nacelle and the fuselage pivot are configured such that the radial holding of the nacelle pivot 19 is greater than that of the fuselage pivot, such that a significant stress exerted on the nacelle 3, which provokes a tilting of the nacelle, causes an identical tilting of the driveshaft 12, and therefore of the fan 6.

Thus, a slight movement of the nacelle 3 causes a corresponding movement of the elements which are in rotation therewith, namely the driveshaft 12 and the fan 6, such that their respective relative position with respect to the nacelle 3 is unchanged. The distance between the end of the blades of the fan 6 and the inner aerodynamic fairing 5 of the nacelle 3 remains unchanged or substantially unchanged compared to the situation in the absence of significant stress exerted on the nacelle, and can thus be kept substantially equal over all the periphery of the fan 6.

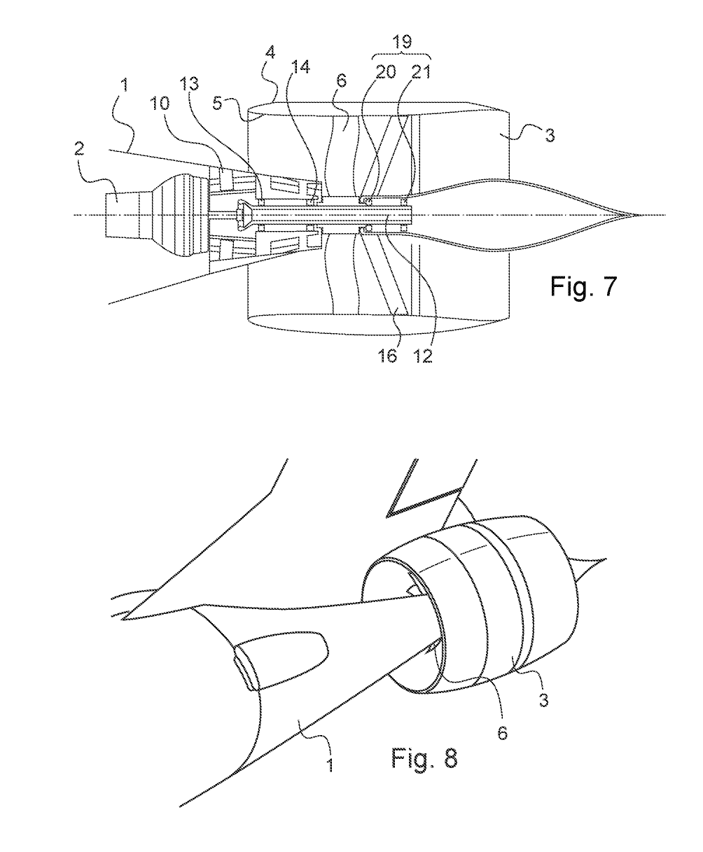

FIG. 7 illustrates, according to a cross-sectional view of an exemplary embodiment of a power unit according to the invention installed in a fuselage rear portion 1. The general configuration of the power unit is similar to that of the power unit which is represented in FIG. 2, such that the description given with reference to FIGS. 1 and 2 applies apart from the differences detailed hereinbelow.

The nacelle pivot 19 is formed by two rolling bearings 20, 21, positioned at a distance from one another around the driveshaft 12. In particular, a third rolling bearing 20 may be a ball bearing, and a fourth rolling bearing 21 may be a roller bearing.

This combination allows a good absorption of the radial and axial loads, namely of the axial loads by the third, ball bearing 20, and of the radial loads essentially by the fourth, roller bearing 21 and partly by the third, ball bearing 20.

No mechanical link is formed in the duct or facing an input of the duct, directly between the engine and the nacelle. Thus, no strut and consequently no strut fairing links the fuselage rear portion and/or the engine (for example in the rear part of the turbojet engine 10).

In the absence of such mechanical links, the general architecture of the power unit is simplified, and its mounting on an aircraft is simplified compared to a power unit mounted according to configuration prior to the invention.

As is clearly visible in FIG. 8, which represents an aircraft rear part equipped with the power unit of FIG. 7, that frees the input of the duct of the nacelle 3 of any element that can hamper the entry of air or disrupt its flow upstream of the fan 6. Furthermore, the absence of elements likely to generate an effect of masking of the blades of the fan avoids the generation of noise associated with that masking.

The invention thus developed proposes a configuration of an aircraft power unit with boundary layer ingestion, intended to be installed in the rear part of an aircraft fuselage, and that makes it possible to limit the deformations under mechanical stresses of the nacelle. That makes it possible to guarantee a constant separation between the fan and the nacelle. The distance between the end of the blades of the fan and the nacelle can be reduced. The efficiency of the power unit is thus enhanced, and can be reliably maintained despite the loads exerted on the nacelle.

Furthermore, the link configuration between the nacelle and the rear part of the aircraft proposed in the invention makes it possible to avoid the presence of obstacles to the flow of the air at the input of the nacelle. That enhances the performance of the power unit and avoids the effects of masking of the fan of the power unit.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. Aircraft power unit, comprising:
an engine having an output shaft linked to a driveshaft of a fan positioned downstream of the engine,
a nacelle,
the fan being included in a duct formed by a nacelle of the power unit,
wherein the nacelle is linked to the driveshaft of the fan by a nacelle pivot formed downstream of the fan.

2. The aircraft power unit according to claim 1, wherein the nacelle pivot is rigidly linked to the nacelle by a set of fixed blades.

3. The aircraft power unit according to claim 1, wherein no direct mechanical link is formed in the duct or facing an input of the duct formed by the nacelle between the engine and the nacelle.

4. The aircraft power unit according to claim 3, wherein the nacelle pivot comprises at least two rolling bearings separated from one another along the driveshaft of the fan.

5. The aircraft power unit according to claim 3, wherein the nacelle pivot comprises at least one ball bearing and one roller bearing.

6. An aircraft rear part, comprising a fuselage rear portion and at least one aircraft power unit according to claim 1, wherein a part of the engine of the power unit is included in the fuselage rear portion and in which no direct mechanical link is formed in the duct or facing an input of the duct formed by the nacelle between the fuselage rear portion and the nacelle.

7. The aircraft rear part according to claim 6, wherein the driveshaft of the fan is linked to the fuselage rear portion by at least two rolling bearings separated from one another along the driveshaft of the fan.

8. The aircraft rear part according to claim 7, wherein the at least two rolling bearings comprise at least one ball bearing and one roller bearing.

9. An aircraft comprising a rear part according to claim 6.
